(19) United States
(12) Patent Application Publication
(10) Pub. No.: US 2026/0257451 A1
(43) Pub. Date: Sep. 3, 2026

(54) UNDERCOVER COMPRISING REGENERATED FIBER AND METHOD FOR MANUFACTURING THE SAME

(71) Applicants: Hyundai Motor Company, Seoul (KR); Kia Corporation, Seoul (KR)

(72) Inventors: YongBeom Lee, Hwaseong-si (KR); JungWook Lee, Hwaseong-si (KR); Young Ho Choi, Hwaseong-si (KR); Seung Han Choi, Ulsan (KR)

(73) Assignees: Hyundai Motor Company, Seoul (KR); Kia Corporation, Seoul (KR)

(21) Appl. No.: 19/249,858

(22) Filed: Jun. 25, 2025

(30) Foreign Application Priority Data
Feb. 28, 2025 (KR) 10-2025-0026519

(51) Int. Cl. B32B 5/02; B32B 5/06; B32B 5/26; B32B 37/10; B32B 37/18; B32B 38/00; B32B 38/04

(52) U.S. Cl. CPC B32B 5/022; B32B 5/06; B32B 5/266; B32B 37/10; B32B 37/182; B32B 38/004; B32B 38/04; B32B 2038/0056; B32B 2038/042; B32B 2250/20; B32B 2262/0276; B32B 2262/144; B32B 2305/70; B32B 2307/546; B32B 2307/7376; B32B 2367/00

(57) ABSTRACT

The present disclosure relates to an undercover comprising a regenerated fiber and a method for manufacturing the same. One embodiment of the present disclosure provides an undercover including a non-woven fabric, wherein the non-woven fabric includes a regenerated fiber prepared from a regenerated raw material including regenerated flakes containing recycled resin and virgin chips containing virgin resin, and a binder fiber.

### CROSS-REFERENCE TO RELATED APPLICATION

This present application claims the benefit of priority to Korean Patent Application No. 10-2025-0026519, filed on Feb. 28, 2025, in the Korean Intellectual Property Office, the entire disclosure of which is incorporated herein by reference in its entirety.

### FIELD

The present disclosure relates to an undercover comprising a regenerated fiber and a method for manufacturing the same.

### BACKGROUND

Several leading nations are actively developing resource circulation systems aimed at minimizing waste generation across the entire life cycle of products, encompassing production, distribution, consumption, and disposal, while also prioritizing the reuse of existing waste. To accomplish this objective, a variety of environmental regulations are being enacted, prompting companies to adopt sustainability as a core principle, with a focus on promoting eco-friendly practices and achieving zero carbon emissions in their operational frameworks. This approach attempts to addresses environmental concerns, as well as align with other broader global initiatives for sustainable development, thereby attempting to emphasize the importance of responsible consumption and production.

In recent years, the increasing demand for eco-friendly vehicles has underscored the importance of enhancing the image of green alternatives, such as hydrogen and electric vehicles. Concurrently, the European Union (EU) has enacted stricter regulations within the automotive industry, thereby amplifying the need for the development of both interior and exterior materials derived from recycled sources. The EU's directive regarding end-of-life vehicles establishes an ambitious target of achieving a 95% recycling and recovery rate for automotive components, thereby incentivizing manufacturers to strengthen resource circulation systems and promote sustainability within the automotive manufacturing process.

In response to emerging regulatory frameworks and environmental trends, leading companies in Europe and the United States are intensifying their efforts to develop resource-circulating technologies that facilitate the recycling of waste generated from end-of-life vehicles for incorporation into new vehicle production. Nevertheless, many automotive components, such as luggage trims and undercovers, are currently fabricated from composite materials that are formed by thermally bonding polypropylene boards with polyester-based non-woven fabrics. These materials pose significant recycling challenges, as they are predominantly processed for energy recovery via incineration rather than being repurposed into new products. Thus, there is an urgent need for improvement in material design to overcome these recycling obstacles and advance sustainability within the automotive sector.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

An aspect of the present disclosure is directed to providing an eco-friendly undercover comprising a regenerated fiber, and a method for manufacturing the same.

Another aspect of the present disclosure is directed to providing an eco-friendly undercover with improved mechanical properties as well as environmental benefits due to the inclusion of a regenerated fiber, and a method for manufacturing the same.

Embodiments of the present disclosure provides an undercover comprising a non-woven fabric, wherein the non-woven fabric includes a regenerated fiber prepared from a regenerated raw material comprising regenerated flakes containing a recycled resin and virgin chips containing a virgin resin, and a binder fiber.

In one embodiment, the regenerated fiber includes 50 wt % or more of the recycled resin based on a total weight of the regenerated fiber.

In one embodiment, the recycled resin and the virgin resin may each independently include one or more selected from the group consisting of polyethylene, polypropylene, or polyethylene terephthalate.

In one embodiment, the regenerated flakes has a length of 1 mm to 10 mm, a width of 1 mm to 8 mm, and a thickness of 0.5 mm to 5 mm.

In one embodiment, the regenerated fiber has a fineness of 5 denier to 10 denier.

In one embodiment, the regenerated fiber has a strength of 3.5 g/denier or more.

In one embodiment, the non-woven fabric includes 20 wt % to 60 wt % of the regenerated fiber, and 40 wt % to 80 wt % of the binder fiber.

In one embodiment, the binder fiber includes a low-melting-point polyethylene terephthalate fiber.

In one embodiment, the undercover has a structure in which two or more non-woven fabrics are layered.

In one embodiment, the undercover has a thickness of 3 mm or less.

In one embodiment, the undercover has a flexural strength of 15 MPa or more as measured according to ASTM C393.

In one embodiment, the undercover has a flexural load of 20 N or more as measured according to ASTM D790.

In one embodiment, the undercover has a flexural displacement of 20 mm or more as measured according to ASTM D790.

In one embodiment, the undercover has a flexural modulus of 1000 MPa or more as measured according to ASTM D790.

In one embodiment, the undercover has a moisture absorption rate of less than 1%.

Furthermore, embodiments of the present disclosure provides a method for manufacturing an undercover, the method including preparing a regenerated fiber from a regenerated raw material comprising regenerated flakes and virgin chips, preparing a non-woven fabric comprising the regenerated fiber and a binder fiber, and integrating two or more non-woven fabrics by layering and needle-punching the two or more non-woven fabrics.

In one embodiment, the regenerated raw material has a moisture content of 100 ppm or less.

In one embodiment, the method includes molding, with a mold, an integrated product formed in the integrating.

In one embodiment, the molding includes introducing the integrated product without preheating into a preheated mold, and pressing with the mold with steam being sprayed onto the integrated product.

In one embodiment, the pressing with the mold includes pressing with a mold preheated to 150° C. to 200° C. with steam at 150° C. to 170° C. being sprayed onto the integrated product.

The present disclosure provides an environmentally friendly undercover with improved mechanical properties due to the inclusion of the regenerated fiber.

The undercover according to the present disclosure has improved flexural strength, flexural load, flexural displacement, and flexural modulus despite being prepared using regenerated fiber.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a cross-sectional view of an undercover according to one embodiment of the present disclosure.

FIG. 2 is a diagram illustrating a sound absorption coefficient of an undercover according to one embodiment.

### DETAILED DESCRIPTION

Embodiments described in the present specification can be modified into various other forms, and the technology according to exemplary embodiments is not limited to the embodiments described below. The exemplary embodiments are provided to make the description of the present disclosure thorough and to fully convey the scope of the present disclosure to those skilled in the art.

Singular forms “a,” “an,” and “the” used in the specification and the appended claims are intended to include plural referents unless the context clearly dictates otherwise.

In addition, numerical ranges used in this specification include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

Furthermore, reference throughout the specification to “including” or “comprising” a constituent element means that, unless specifically stated to the contrary, other constituent elements are not excluded and may be included.

One embodiment of the present disclosure relates to an eco-friendly undercover comprising regenerated fiber and a method for manufacturing the same. The undercover has the dual advantages of being environmentally friendly while maintaining improved mechanical properties due to the inclusion of regenerated fiber.

According to one embodiment, the undercover includes a non-woven fabric including a regenerated fiber prepared from a regenerated raw material comprising regenerated flakes containing a recycled resin and virgin chips containing virgin resin, and a binder fiber.

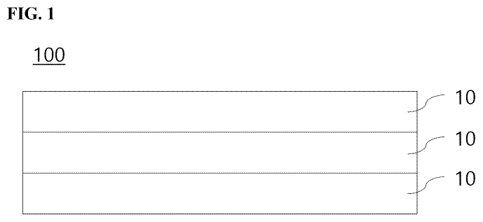

FIG. 1 illustrates an undercover according to one embodiment of the present disclosure.

The following is a detailed description of the undercover according to one embodiment of the present disclosure with reference to the attached drawings. The attached drawings are provided merely as examples to convey the technical concepts of the present disclosure to persons skilled in the art and are not intended to limit the present disclosure, which may be embodied in various other forms.

Referring to FIG. 1, an undercover (100) has a structure in which two or more non-woven fabrics (10) are layered. According to FIG. 1, an undercover (100) with three layers of non-woven fabrics (10) is illustrated, but the present disclosure is not limited thereto. For example, according to one embodiment, the undercover (100) has 2 to 10 layers or 2 to 5 layers of non-woven fabrics (10) layered.

The undercover (100) includes a structural sheet (not shown) in addition to the non-woven fabric (10). The structural sheet may be inserted between non-woven fabrics (10). The structural sheet provides noise reduction, insulation, impact absorption, and structural strength. The structural sheet may be made of lightweight materials to improve fuel efficiency. The structural sheet includes various fibers known in the art, and as non-limiting examples, includes polypropylene, polyester, glass fiber, rayon, nylon, or a combination thereof.

The non-woven fabric (10) is a fabric formed by entangled fibers and includes a regenerated fiber and a binder fiber. The binder fiber may function to bind and fix the regenerated fiber within the non-woven fabric (10).

The regenerated fiber includes a recycled resin and a virgin resin. The regenerated fiber includes 50 wt % or more or 70 wt % or more of the recycled resin based on the total weight of the regenerated fiber. The upper limit of the recycled resin content is not particularly limited, and may be, for example, 100 wt % or less, 99 wt % or less, 95 wt % or less, or 90 wt % or less. If the recycled resin content is less than 50 wt %, the content of virgin resin becomes relatively large, making it difficult to achieve the purpose of using recycled resin.

The recycled resin and the virgin resin may each independently include one or more selected from the group consisting of polyethylene, polypropylene, or polyethylene terephthalate. For example, the recycled resin and virgin resin includes polyethylene terephthalate.

The regenerated fiber may be prepared from a regenerated raw material including regenerated flakes containing recycled resin and virgin chips containing virgin resin. For example, the regenerated fiber may be prepared by melting and spinning the regenerated raw material.

In one embodiment, the regenerated raw material used to prepare the regenerated fiber includes regenerated flakes. The regenerated flakes may be ground material produced by washing and crushing discarded plastics. The regenerated flakes may be distinguished from regenerated chips in terms of form and processing method. The regenerated chips may be melt-extruded products obtained by melting and extruding the regenerated flakes.

In one embodiment, the regenerated raw material includes regenerated flakes and not regenerated chips. Accordingly, since regenerated chips are about twice as expensive as regenerated flakes, this is advantageous in terms of price competitiveness.

In one embodiment, the recycled resin included in the regenerated fiber may be derived from regenerated flakes. 90% or more, 95% or more, or 100% of the recycled resin may be derived from regenerated flakes. Accordingly, the undercover (100) according to one embodiment has greater price competitiveness by utilizing regenerated flakes, which are less expensive than regenerated chips.

The regenerated flakes may be obtained through post-consumer recycled (PCR) content or post-industrial recycled (PIR) content. PCR refers to waste plastics such as water bottles, CDs, appliance cases, and the like used in daily life that are recycled to prevent them from becoming household waste. PIR refers to waste generated during the factory injection molding process of products that is recycled.

The undercover (100) according to one embodiment of the present disclosure may be cost-effective by using regenerated flakes rather than regenerated chips. Additionally, the undercover (100) according to one embodiment has improved mechanical properties as well as cost advantages by using regenerated flakes with specific properties, either together with virgin chips or alone.

The regenerated flakes has a length of 1 mm to 10 mm, a width of 1 mm to 8 mm, and a thickness of 0.5 mm to 5 mm. The regenerated flakes has a length of 2 mm to 7 mm, a width of 1 mm to 5 mm, and a thickness of 0.5 mm to 2 mm. When the size of the regenerated flakes falls within these numerical ranges, the regenerated flakes and virgin chips may be uniformly mixed to provide an undercover (100) with improved mechanical properties.

The regenerated flakes has an intrinsic viscosity of 0.62 dl/g to 0.8 dl/g. When the intrinsic viscosity of the regenerated flakes falls within this numerical range, the regenerated flakes and virgin chips may be uniformly mixed to provide an undercover (100) with improved mechanical properties.

The regenerated flakes has a melting point of 250° C. to 270° C. or 256° C. to 267° C. When the melting point of the regenerated flakes falls within this numerical range, the regenerated flakes and virgin chips may be uniformly mixed to provide an undercover (100) with improved mechanical properties.

The regenerated flakes has a moisture content of 300 ppm or less or 250 ppm or less. The lower limit of the moisture content may be, for example, 10 ppm or more, 50 ppm or more, or 100 ppm or more, but is not particularly limited thereto. When the moisture content of the regenerated flakes falls within this numerical range, the moisture content of the regenerated raw material may be adjusted to 100 ppm or less after dehumidification, providing an undercover (100) with improved mechanical properties. Here, the moisture content of the regenerated flakes can be measured using a moisture tester, and the measurement method may adopt the Karl Fischer moisture measurement method, and the measurement device may adopt a Swiss Metrohm 831 type Karl Fischer moisture tester.

The regenerated fiber provides an undercover (100) with improved mechanical properties as it is prepared from a regenerated raw material including the above-described regenerated flakes and virgin chips.

The fineness of the regenerated fiber may be 5 denier to 10 denier, or 6 denier to 8 denier. Here, fineness refers to the thickness of the fiber, and when the length of a fiber with a total mass of 1 g is 9000 m, the thickness of this fiber is called 1 denier. The lower the denier, the thinner and softer the fiber may be.

The strength of the regenerated fiber may be 3.5 g/denier or more, 3.7 g/denier or more, 3.8 g/denier or more, or 4.0 g/denier or more. The upper limit of the strength of the regenerated fiber may be 10 g/denier or less, 8 g/denier or less, or 5 g/denier or less, but is not particularly limited thereto.

The binder fiber includes a low-melting-point polyethylene terephthalate fiber. The low-melting-point polyethylene terephthalate fiber has a melting point of 100° C. to 180° C. or 110° C. to 180° C., which is considerably lower compared to the melting point of regular polyethylene terephthalate fiber, which is 240° C. to 260° C.

The non-woven fabric (10) includes 20 wt % to 60 wt % of regenerated fiber and 40 wt % to 80 wt % of binder fiber. For example, the non-woven fabric (10) includes 30 wt % to 50 wt % of regenerated fiber, and 50 wt % to 70 wt % of binder fiber. When the content of regenerated fiber and binder fiber falls within these numerical ranges, the mechanical properties of the non-woven fabric (10) may be improved.

The thickness of the undercover (100) may be 3 mm or less, or 1 mm to 3 mm. Compared to existing undercovers (100) with a thickness of 3.5 mm or more, the undercover (100) according to one embodiment has a thinner thickness.

The undercover (100) according to one embodiment has improved mechanical properties even with a thin thickness.

The undercover (100) has a flexural strength of 15 MPa or more as measured according to ASTM C393. The undercover (100) has a flexural strength of 16 MPa or more, 17 MPa or more, 18 MPa or more, or 20 MPa or more, and the upper limit may be, but is not limited to, 30 MPa or less or 25 MPa or less. Here, the flexural strength of the undercover (100) may refer to the average value of the flexural strength in the machine direction (MD) and the flexural strength in the transverse direction (TD).

The undercover (100) has a flexural load of 20 N or more as measured according to ASTM D790. The undercover (100) has a flexural load of 22 N or more, 23 N or more, 24 N or more, or 25 N or more, and the upper limit may be, but is not limited to, 35 N or less or 30 N or less. Here, the flexural load of the undercover (100) may refer to the average value of the flexural load in the machine direction (MD) and the flexural load in the transverse direction (TD).

The undercover (100) has a flexural displacement of 20 mm or more as measured according to ASTM D790. For example, the flexural displacement of the undercover (100) may be 20 mm to 25 mm. Here, the flexural displacement of the undercover (100) may refer to the average value of the flexural displacement in the machine direction (MD) and the flexural displacement in the transverse direction (TD).

The undercover (100) has a flexural modulus of 1000 MPa or more as measured according to ASTM D790. The undercover (100) has a flexural modulus of 1100 MPa or more, 1200 MPa or more, or 1500 MPa or more, and the upper limit may be, but is not limited to, 2000 MPa or less or 1700 MPa or less. Here, the flexural modulus of the undercover (100) may refer to the average value of the flexural modulus in the machine direction (MD) and the flexural modulus in the transverse direction (TD).

By having flexural strength, flexural load, flexural displacement, and flexural modulus within the above-mentioned ranges, the undercover (100) can perform its role as an automotive undercover (100) despite utilizing regenerated flakes.

The undercover (100) has a sound absorption coefficient at 1000 Hz of 0.2 or more, 0.24 or more, 0.35 or less, 0.3 or less, or values between these figures. For example, the undercover (100) has a sound absorption coefficient at 1000 Hz of 0.2 to 0.35 or 0.24 to 0.3.

The undercover (100) has a sound absorption coefficient at 2000 Hz of 0.35 or more, 0.4 or more, 0.5 or less, 0.45 or less, or values between these figures. For example, the undercover (100) has a sound absorption coefficient at 2000 Hz of 0.35 to 0.5 or 0.4 to 0.45.

The undercover (100) has a sound absorption coefficient at 3150 Hz of 0.45 or more, 0.48 or more, 0.6 or less, 0.55 or less, or values between these figures. For example, the undercover (100) has a sound absorption coefficient at 3150 Hz of 0.45 to 0.6 or 0.48 to 0.55.

The undercover (100) has a sound absorption coefficient at 5000 Hz of 0.5 or more, 0.55 or more, 0.65 or less, 0.6 or less, or values between these figures. For example, the undercover (100) has a sound absorption coefficient at 5000 Hz of 0.5 to 0.65 or 0.55 to 0.6.

By utilizing regenerated flakes, the undercover (100) may exhibit sound absorption coefficients at major frequencies similar to those of products on the market, as described above. This allows for providing an undercover (100) with improved performance at a low cost.

The undercover (100) has a moisture absorption rate of less than 1%, 0.5% or less, or 0.1% or less. The moisture absorption rate of the undercover (100) may be 0%.

The moisture absorption rate may be calculated using Formula 1 below.

$$Moisture absorption rate = \{ ( {w}_{1} - {w}_{0} ) / {w}_{0} \} \times 100 \qquad [ Formula 1 ]$$

In Formula 1, w₀ is the weight of a specimen measured under standard laboratory conditions (temperature 23±2° C., relative humidity 50±5%) before immersion. w₁ is the weight of the specimen measured after immersion in warm water at (40±2° C.) for 1 hour and standing under standard laboratory conditions for 24 hours.

The undercover (100) has a weight of 1000 g/m² to 2000 g/m² or 1000 g/m² to 1500 g/m².

In addition, the present disclosure provides a method for manufacturing an undercover (100), the method including preparing a regenerated fiber from a regenerated raw material including regenerated flakes and virgin chips (S1), preparing a non-woven fabric (10) including the regenerated fiber and a binder fiber (S2), and integrating two or more non-woven fabrics (10) by layering and needle-punching the two or more non-woven fabrics (S3).

Since the regenerated flakes, virgin chips, regenerated fiber, binder fiber, non-woven fabric (10), and undercover (100) have been described above, a detailed explanation is omitted.

S1 is a step of preparing a regenerated fiber from a regenerated raw material including regenerated flakes and virgin chips.

S1 includes preparing a regenerated raw material including regenerated flakes and virgin chips, dehumidifying the regenerated raw material, obtaining a melt by melting the dehumidified regenerated raw material, and spinning the melt.

S1 includes filtering the dehumidified regenerated raw material to remove foreign substances before the obtaining a melt.

The regenerated raw material includes 50 wt % or more or 70 wt % or more of the regenerated flakes based on the total weight of the regenerated raw material. The upper limit of the regenerated flake content is not particularly limited, and may be 100 wt % or less, 99 wt % or less, 95 wt % or less, or 90 wt % or less. If the content of regenerated flakes is less than 50 wt %, the content of virgin chips becomes relatively large, making it impossible to achieve the purpose of using regenerated flakes.

The regenerated flakes and the virgin chips may each independently include one or more selected from the group consisting of polyethylene, polypropylene, or polyethylene terephthalate. For example, the regenerated flakes and virgin chips includes polyethylene terephthalate.

The regenerated raw material has a moisture content of 100 ppm or less, and when the moisture content falls within this range, the mechanical properties of the regenerated fiber and undercover (100) may be improved to the level targeted by the present disclosure. Here, the moisture content of the regenerated raw material may be measured using a moisture tester, and the measurement method may adopt the Karl Fischer moisture measurement method, and the measurement device may adopt a Swiss Metrohm 831 type Karl Fischer moisture tester.

The moisture content of the regenerated raw material within the above range may be obtained by the dehumidifying of the regenerated raw material. The dehumidifying of the regenerated raw material includes a first drying step and a second drying step. The first drying step includes drying the regenerated raw material at 140° C. to 170° C. for 1 hour to 10 hours, and the second drying step includes drying the resulting product at 150° C. to 180° C. for 30 minutes to 3 hours. However, the above-mentioned dehumidification conditions are not limited to these and may be changed if they can achieve a regenerated raw material with a moisture content of 100 ppm or less.

Various types of equipment may be used for the dehumidification process as long as they can adjust the moisture content to within the above range. For example, the first drying step may be performed while agitating the regenerated raw material with a thermal agitator. The second drying step may be performed in a chamber loaded with molecular sieve desiccant after the first drying of the regenerated raw material. Also, the chamber includes a device that applies heat using a hot air heater method.

Foreign substances can be removed by filtering the dehumidified regenerated raw material in a manner known in the art. For example, foreign substances can be removed by introducing the dehumidified regenerated raw material into a screen changer or bar-type filter equipment. The screen changer may be equipped with a 3-port hydraulic cylinder and a Mash-type filter. The bar-type filter equipment refers to equipment with multiple bar-shaped filters installed, and the filter arrangement is not limited to a specific method but can be designed in an appropriate manner to enhance the effect of removing foreign substances.

A melt may be obtained by melting the dehumidified raw material or regenerated raw material from which foreign substances have been removed in a manner known in the art. The intrinsic viscosity (IV) of the melt may be 0.62 dl/g to 0.68 dl/g. When the intrinsic viscosity of the melt falls within this range, processability and mechanical properties may be implemented at the level targeted by the present disclosure.

A regenerated fiber may be prepared by spinning the melt. The spinning method is not particularly limited and may adopt methods commonly used in the art to which the present disclosure pertains.

Post-treatment may be performed on the regenerated fiber. For example, the regenerated fiber may be drawn and cut. For example, the regenerated fiber may be drawn at 50° C. to 75° C. with a drawing ratio of 1 to 10, and then the drawn fiber may be cut to a certain length.

S2 is a step of preparing a non-woven fabric (10) including the regenerated fiber and a binder fiber. The preparing the non-woven fabric (10) includes preparing yarn by blending the regenerated fiber and a binder fiber, and preparing a non-woven fabric (10) by carding the yarn.

The yarn includes 20 wt % to 60 wt % of regenerated fiber, and 40 wt % to 80 wt % of binder fiber. For example, the non-woven fabric (10) includes 30 wt % to 50 wt % of regenerated fiber, and 50 wt % to 70 wt % of binder fiber. When preparing yarn by blending regenerated fiber and binder fiber within these content ranges, the mechanical properties of the non-woven fabric (10) being prepared may be improved.

The non-woven fabric (10) may be prepared by carding the yarn. The carding method is not particularly limited and may adopt methods commonly used in the art to which the present disclosure pertains.

S3 is a step of integrating two or more non-woven fabrics (10) by layering and needle-punching the two or more non-woven fabrics (10). The undercover (100) may be manufactured by integrating two or more non-woven fabrics (10) by layering and needle-punching the two or more non-woven fabrics (10). For example, two or more non-woven fabrics (10) may be needle-punched using a needle-punching machine with a needle depth of 6.0 mm to 13.0 mm. The two or more non-woven fabrics (10) may be needle-punched at a progression speed of 5 m/min to 10 m/min. The two or more non-woven fabrics (10) may be needle-punched at a stroke of 400 RPM to 800 RPM. By satisfying these needle-punching conditions, an undercover (100) with improved mechanical properties such as flexural strength and flexural modulus may be manufactured.

The number of layers of the non-woven fabrics (10) is not particularly limited and may be appropriately adjusted according to the thickness, use, and the like of the intended product. For example, 2 to 10 layers or 2 to 5 layers of non-woven fabrics (10) may be layered and integrated.

In one embodiment, the method for manufacturing the undercover (100) includes molding, with a mold, an integrated product formed in the integrating.

The molding includes introducing the integrated product without preheating into a preheated mold, and pressing with the mold with steam being sprayed onto the integrated product. Since the non-woven fabric (10) does not need to be preheated, its thickness does not need to be increased, allowing for the manufacture of an undercover (100) with a thin thickness that would not be possible with existing molding methods. Additionally, by spraying steam during thermal molding, flexibility may be added to the non-woven fabric (10).

The pressing with the mold includes pressing with a mold preheated to 150° C. to 200° C. with steam at 150° C. to 170° C. being sprayed onto the integrated product. In one embodiment, the pressing with the mold includes pressing with a mold preheated to 150° C. to 200° C. for 25 seconds to 100 seconds or 50 seconds to 70 seconds, with steam at 150° C. to 170° C. being sprayed onto the integrated product for 5 seconds to 60 seconds or 10 seconds to 20 seconds.

The molding includes cooling the pressed result by placing it on a cooling jig. By cooling on a cooling jig, the shape of the pressed result after thermal molding may be fixed. The following specifically illustrates and describes examples below. However, the following examples are only illustrative, and the technology described in this specification is not limited thereto.

### Methods for Measuring Properties

The fineness of the fibers prepared in the Manufacturing Examples was measured in accordance with ASTM D1577.

The strength and elongation of the fibers prepared in the Manufacturing Examples were measured in accordance with ASTM D2256.

The crimp count of the fibers prepared in the Manufacturing Examples was measured in accordance with ASTM D3937.

The fiber length of the fibers prepared in the Manufacturing Examples was measured in accordance with ASTM D1447.

The shrinkage rate of the fibers prepared in the Manufacturing Examples was measured in accordance with ASTM D2259.

The flexural strength of the undercovers prepared in the examples was measured in accordance with ASTM C393.

The flexural load, flexural displacement, and flexural modulus of the undercovers prepared in the examples were measured in accordance with ASTM D790.

### Manufacturing Example 1

Regenerated flakes with a length of 5 mm, a width of 4 mm, and a thickness of 1 mm were prepared. The regenerated flakes were collected through post-consumer recycled (PCR) content and included polyethylene terephthalate. Regenerated flakes with an intrinsic viscosity of 0.77 dl/g and a melting point of 256° C. were used. A regenerated raw material was prepared by mixing 50 wt % of the regenerated flakes and 50 wt % of virgin chips. The virgin chips included polyethylene terephthalate. The regenerated raw material was first dried at 160° C. for 4 hours using a thermal agitator, and then dehumidified by secondary drying at 160° C. for 1 hour using a hot-air heater method and molecular sieve desiccant. The moisture content of the dehumidified regenerated raw material was controlled to be 100 ppm or less. Trace amounts of foreign substances in the regenerated raw material were removed using a screen changer. The regenerated raw material was melted at 285° C. and then spun to obtain a regenerated fiber.

### Manufacturing Example 2

A regenerated fiber was prepared in the same manner as in Manufacturing Example 1 except that a regenerated raw material was prepared by mixing 75 wt % of regenerated flakes and 25 wt % of virgin chips.

### Manufacturing Example 3

A regenerated fiber was prepared in the same manner as in Manufacturing Example 1 except that 100 wt % of regenerated flakes were used as the regenerated raw material.

### Comparative Manufacturing Example

A regenerated fiber was prepared in the same manner as in Manufacturing Example 1 except that 100 wt % of virgin chips were used as the regenerated raw material.

The fineness, strength, and the like of each regenerated fiber prepared in Manufacturing Examples 1 to 3 and the Comparative Manufacturing Example were measured and are shown in Table 1 below.

TABLE 1

| | | | | Comparative |
|---|---|---|---|---|
| | Manufacturing | Manufacturing | Manufacturing | Manufacturing |
| Property | Example 1 | Example 2 | Example 3 | Example |
| Fineness [denier] | 7.33 | 7.38 | 7.29 | 7.13 |
| Coefficient of | 7.9 | 8.3 | 9.7 | 9.3 |
| variation [%] | | | | |
| Strength | 3.82 | 3.94 | 4.25 | 4.08 |
| [g/denier] | | | | |
| Elongation [%] | 70.6 | 63.8 | 66.0 | 71.4 |
| Crimp count | 8.0 | 7.8 | 8.1 | 7.7 |
| [number/in] | | | | |
| Fiber length | 51.4 | 51.2 | 51.4 | 50.6 |
| [mm] | | | | |
| Shrinkage rate | 3.5 | 3.7 | 3.3 | 3.3 |
| [%] | | | | |

As shown in Table 1, the regenerated fibers of Manufacturing Examples 1 and 2, which were prepared from a regenerated raw material including regenerated flakes, exhibit mechanical properties equivalent to those of the Comparative Manufacturing Example. Additionally, Manufacturing Example 3, which was prepared solely from regenerated flakes, has superior strength compared to the Comparative Manufacturing Example.

### Example 1

Yarn was prepared by blending 40 wt % of the regenerated fiber from Manufacturing Example 1 and 60 wt % of a binder fiber. The binder fiber included a low-melting-point polyethylene terephthalate fiber with a melting point of 110° C. Three layers of non-woven fabric obtained by carding the yarn were layered, then needle-punched and integrated using a needle depth of 9.5 mm, a progression speed of 5 m/min, and a stroke of 610 RPM. The integrated product was introduced into a mold preheated to 200° C. and molded for 35 seconds to prepare a specimen. The mold used a mini press equipment with a heating plate preheating method.

### Example 2

A specimen was prepared in the same manner as in Example 1 except that the regenerated fiber from Manufacturing Example 2 was used.

### Example 3

A specimen was manufactured in the same manner as in Example 1 except that the regenerated fiber from Manufacturing Example 3 was used.

### Comparative Example 1

A specimen was prepared in the same manner as in Example 1 except that the regenerated fiber from the Comparative Manufacturing Example was used.

The flexural strength, flexural load, flexural modulus, thickness, and basis weight of each specimen prepared in Examples 1 to 3 and Comparative Example 1 were measured. Each property was measured in both the machine direction (MD) and transverse direction (TD). A total of 7 measurements were taken for each property and the average values were calculated and are shown in Table 2 below.

TABLE 2

| | | Flexural | Flexural | Flexural | | |
|---|---|---|---|---|---|---|
| | | strength | load | modulus | Thickness | Weight |
| | | [MPa] | [N] | [MPa] | [mm] | [g/m²] |
| Example 1 | MD | 18.17 | 24.23 | 1530.78 | 2.01 | 1200.71 |
| | TD | 18.38 | 24.51 | 1547.80 | 2.01 | 1200.86 |
| Example 2 | MD | 18.27 | 24.37 | 1528.84 | 2.01 | 1199.43 |
| | TD | 19.18 | 25.57 | 1585.75 | 2.01 | 1201.71 |
| Example 3 | MD | 20.30 | 27.07 | 1544.01 | 2.02 | 1199.43 |
| | TD | 21.48 | 27.76 | 1582.63 | 2.02 | 1201.43 |
| Comparative | MD | 20.60 | 27.47 | 1571.02 | 2.01 | 1200.14 |
| Example 1 | TD | 21.50 | 27.82 | 1620.48 | 2.02 | 1200.71 |

Referring to Table 2, Examples 1 to 3 have improved mechanical properties with flexural strength of 18 MPa or more, flexural load of 24 N or more, and flexural modulus of 1500 MPa or more. In particular, Example 3 exhibits excellent mechanical properties with mechanical properties equivalent to or improved compared to Comparative Example 1.

### Example 4

Yarn was prepared by blending 40 wt % of the regenerated fiber from Manufacturing Example 1 and 60 wt % of a binder fiber. The binder fiber included a low-melting-point polyethylene terephthalate fiber with a melting point of 110° C. Three layers of non-woven fabric obtained by carding the yarn were layered, then needle-punched and integrated using a needle depth of 9.5 mm, a progression speed of 5 m/min, and a stroke of 610 RPM. The density of the integrated product was 1,200 g/cm². The integrated product was preheated for 65 seconds on a hot plate set at about 210° C., then introduced into a mold preheated to about 200° C. and molded for about 35 seconds. The undercover was prepared by additional molding for about 50 seconds in a cooling mold.

### Example 5

An undercover was manufactured in the same manner as in Example 4 except that the regenerated fiber from Manufacturing Example 2 was used.

### Example 6

An undercover was manufactured in the same manner as in Example 4 except that the regenerated fiber from Manufacturing Example 3 was used.

### Comparative Example 2

An undercover was prepared in the same manner as in Example 4 except that regenerated fiber from Comparative Manufacturing Example was used.

The maximum strength, flexural load, flexural displacement, flexural modulus, thickness, and weight of each undercover manufactured in Examples 4 to 6 and Comparative Example 2 were measured. Each property was measured in both the machine direction (MD) and transverse direction (TD). A total of 7 measurements were taken for each property and the average values were calculated and are shown in Table 3 below.

TABLE 3

| | | Flexural | Flexural | Flexural | Flexural | | |
|---|---|---|---|---|---|---|---|
| | | strength | load | displacement | modulus | Thickness | Weight |
| | | [MPa] | [N] | [mm] | [MPa] | [mm] | [g/m²] |
| Example 4 | MD | 17.37 | 23.16 | 20.96 | 1119.36 | 2.1 | 1211 |
| | TD | 17.42 | 23.22 | 22.01 | 1140.21 | 2.1 | 1208.8 |
| Example 5 | MD | 17.26 | 23.01 | 22.89 | 1119.57 | 2.11 | 1210 |
| | TD | 17.08 | 22.77 | 22.47 | 1137.7 | 2.11 | 1209.6 |
| Example 6 | MD | 19.05 | 25.41 | 23.1 | 1279.89 | 2.1 | 1209.4 |
| | TD | 17.96 | 23.95 | 20.04 | 1187.67 | 2.11 | 1207.2 |
| Comparative | MD | 18.98 | 25.3 | 20.46 | 1240.27 | 2.12 | 1211.8 |
| Example 2 | TD | 17.72 | 23.62 | 23.31 | 1105.01 | 2.12 | 1207 |

Referring to Table 3, Examples 4 to 6 have improved mechanical properties with flexural strength of 17 MPa or more, flexural load of 22 N or more, and flexural modulus of 1100 MPa or more. In particular, Example 6 exhibits excellent mechanical properties with mechanical properties equivalent to or improved compared to Comparative Example 2.

The moisture absorption rate of each undercover manufactured in Examples 4 to 6 and Comparative Example 2 was measured. The moisture absorption rate was calculated using Formula 1 below. Specifically, test specimens with a length of 150 mm and a width of 50 mm were collected and evaluated after immersion in warm water at (40±2° C.) for 1 hour, followed by 24 hours under standard laboratory conditions (temperature 23±2° C., relative humidity 50±5%). A scale capable of measuring to the third decimal place (0.001 g) was used to measure to the third decimal place. Measurements were taken for 5 specimens and the arithmetic mean was recorded, and the results are shown in the Table 4 below.

$$Moisture absorption rate = \{ ( {w}_{1} - {w}_{0} ) / {w}_{0} \} \times 100 \qquad [ Formula 1 ]$$

In Formula 1, w₀ is the weight of the specimen before immersion, and w₁ is the weight of the specimen after immersion.

TABLE 4

| | | | | Moisture |
|---|---|---|---|---|
| | | | | absorption |
| | Classification | w₀ | w₁ | rate [%] |
| Example 4 | #1 | 9.046 | 9.047 | 0 |
| | #2 | 9.072 | 9.072 | 0 |
| | #3 | 9.042 | 9.043 | 0 |
| | #4 | 9.152 | 9.152 | 0 |
| | #5 | 9.194 | 9.194 | 0 |
| Example 5 | #1 | 9.142 | 9.143 | 0 |
| | #2 | 9.168 | 9.169 | 0 |
| | #3 | 9.024 | 9.024 | 0 |
| | #4 | 9.156 | 9.157 | 0 |
| | #5 | 9.202 | 9.202 | 0 |
| Example 6 | #1 | 9.164 | 9.166 | 0 |
| | #2 | 9.110 | 9.111 | 0 |
| | #3 | 9.102 | 9.102 | 0 |
| | #4 | 9.294 | 9.294 | 0 |
| | #5 | 9.213 | 9.215 | 0 |
| Comparative | #1 | 9.173 | 9.173 | 0 |
| Example 2 | #2 | 9.051 | 9.052 | 0 |
| | #3 | 9.169 | 9.171 | 0 |
| | #4 | 9.123 | 9.124 | 0 |
| | #5 | 9.174 | 9.174 | 0 |

Referring to Table 4, it can be seen that the undercovers of Examples 4 to 6 have a moisture absorption rate of 0%, meaning they do not absorb water, and can thus protect the parts inside from moisture.

### Examples 7 to 9

Yarn was prepared by blending 40 wt % of the regenerated fiber from Manufacturing Example 3 and 60 wt % of a binder fiber. Three layers of non-woven fabric obtained by carding the yarn were layered, then needle-punched and integrated using a needle depth of 9.5 mm, a progression speed of 5 m/min, and a stroke of 610 RPM. The density of the integrated product was 1,200 g/cm². The undercover was formed by introducing the integrated product into a mold preheated to a specific temperature and pressing with the mold by spraying steam. The specific conditions are shown in Table 5 below.

TABLE 5

| | Mold | | Steam | |
|---|---|---|---|---|
| | Preheating | Pressing | | Spraying |
| | temperature | time | Temperature | time |
| Classification | [° C.] | [sec] | [° C.] | [sec] |
| Example 7 | 185 | 50 | 160 | 10 |
| Example 8 | 185 | 50 | 160 | 20 |
| Example 9 | 185 | 70 | 160 | 20 |

The deflection of the undercovers manufactured in Example 9 and Comparative Example 2 was measured. After placing half of the undercover on a measurement jig, the degree of deflection at the end of the undercover was checked. The deflection in the horizontal and vertical directions of the undercover was evaluated respectively. The specific conditions are shown in the Table 6 below.

TABLE 6

| | Horizontal direction [mm] | | | | | | | |
|---|---|---|---|---|---|---|---|---|
| Classi- | | | | Aver- | Vertical direction [mm] | | | |
| fication | #1 | #2 | #3 | age | #1 | #2 | #3 | Average |
| Comparative | 755 | 755 | 748 | 753 | 800 | 792 | 790 | 794 |
| Example 2 | | | | | | | | |
| Example 9 | 770 | 765 | 770 | 768 | 800 | 795 | 795 | 796 |

Referring to Table 6, the undercover of Example 9 is equivalent to Comparative Example 2 in terms of deflection.

The flexural strength, flexural load, and flexural modulus of the undercovers manufactured in Examples 7 to 9 and Comparative Example 2 were measured. Each property was measured in both the machine direction (MD) and transverse direction (TD). The results are shown in Table 7 below.

TABLE 7

| | | Flexural | Flexural | Flexural |
|---|---|---|---|---|
| | | strength | load | modulus |
| | | [MPa] | [N] | [MPa] |
| Example 7 | MD | 20.75 | 27.67 | 1848.77 |
| | TD | 17.56 | 23.25 | 1962.93 |
| Example 8 | MD | 19.77 | 26.35 | 1914.07 |
| | TD | 17.39 | 23.19 | 2053.37 |
| Example 9 | MD | 21.52 | 27.84 | 2119.52 |
| | TD | 18.43 | 24.58 | 2003.57 |
| Comparative | MD | 19.57 | 26.09 | 1459.87 |
| Example 2 | TD | 16.2 | 22.56 | 1275.27 |

Referring to Table 7, Examples 7 to 9 all have improved properties compared to Comparative Example 2. In particular, Example 9 has about 10% improved flexural strength and flexural load, and about 45% to 60% improved flexural modulus compared to Comparative Example 2.

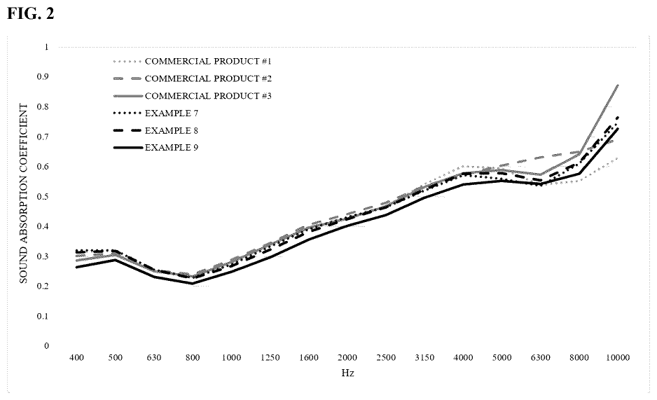

The sound absorption coefficient of the undercovers manufactured in Examples 7 to 9 was measured. Each undercover was placed about 220 mm above the floor and the sound absorption was evaluated. For comparison, the sound absorption coefficients of three different commercial products on the market were also measured. The results are shown in FIG. 2 and Table 8. FIG. 2 is a diagram showing the sound absorption coefficient of the undercovers of Examples 7 to 9 according to frequency. Referring to FIG. 2 and Table 8, it can be seen that the sound absorption coefficients of the undercovers according to the examples do not show a significant performance difference compared to the commercial products. In particular, the sound absorption coefficients at major frequencies of 1000 Hz, 2000 Hz, 3150 Hz, and 5000 Hz appeared at similar levels to those of the commercial products. This shows that embodiments of the present disclosure may be usefully used to reduce the manufacturing cost of products and recycle regenerated flakes.

TABLE 8

| | Commercial | Commercial | Commercial | Example | | |
|---|---|---|---|---|---|---|
| | product #1 | product #2 | product #3 | 7 | Example 8 | Example 9 |
| 400 | 0.314 | 0.3 | 0.286 | 0.32 | 0.313 | 0.263 |
| 500 | 0.318 | 0.309 | 0.304 | 0.319 | 0.318 | 0.287 |
| 630 | 0.254 | 0.253 | 0.25 | 0.254 | 0.254 | 0.231 |
| 800 | 0.232 | 0.239 | 0.233 | 0.228 | 0.226 | 0.208 |
| 1000 | 0.279 | 0.287 | 0.281 | 0.272 | 0.266 | 0.247 |
| 1250 | 0.339 | 0.344 | 0.339 | 0.331 | 0.321 | 0.295 |
| 1600 | 0.397 | 0.405 | 0.395 | 0.389 | 0.381 | 0.356 |
| 2000 | 0.428 | 0.441 | 0.426 | 0.43 | 0.423 | 0.401 |
| 2500 | 0.466 | 0.478 | 0.467 | 0.463 | 0.463 | 0.438 |
| 3150 | 0.541 | 0.535 | 0.532 | 0.519 | 0.523 | 0.496 |
| 4000 | 0.602 | 0.57 | 0.578 | 0.571 | 0.576 | 0.54 |
| 5000 | 0.593 | 0.603 | 0.588 | 0.558 | 0.577 | 0.552 |
| 6300 | 0.538 | 0.631 | 0.572 | 0.535 | 0.553 | 0.541 |
| 8000 | 0.552 | 0.649 | 0.641 | 0.61 | 0.614 | 0.575 |
| 10000 | 0.629 | 0.69 | 0.871 | 0.747 | 0.763 | 0.726 |

Although the scope of the present disclosure has been described by specific matters and limited embodiments in the present specification, the embodiments are provided only for assisting the understanding of the present disclosure more generally, and the present disclosure is not limited to the embodiments disclosed herein. Various modifications and changes may be made to the embodiments by those skilled in the art to which the present disclosure pertains from the description and shall be understood as being included in the embodiments disclosed herein.

What is claimed is:

1. An undercover comprising a non-woven fabric,
wherein the nonwoven fabric comprises:
a regenerated fiber prepared from a regenerated raw material comprising regenerated flakes containing a recycled resin and virgin chips containing a virgin resin; and
a binder fiber.

2. The undercover of claim 1, wherein the regenerated fiber comprises 50 wt % or more of the recycled resin based on a total weight of the regenerated fiber.

3. The undercover of claim 1, wherein the recycled resin and the virgin resin each independently comprise one or more selected from the group consisting of polyethylene, polypropylene, or polyethylene terephthalate.

4. The undercover of claim 1, wherein the regenerated flakes have a length of 1 mm to 10 mm, a width of 1 mm to 8 mm, and a thickness of 0.5 mm to 5 mm.

5. The undercover of claim 1, wherein the regenerated fiber has a fineness of 5 denier to 10 denier.

6. The undercover of claim 1, wherein the regenerated fiber has a strength of 3.5 g/denier or more.

7. The undercover of claim 1, wherein the non-woven fabric comprises:
20 wt % to 60 wt % of the regenerated fiber; and
40 wt % to 80 wt % of the binder fiber.

8. The undercover of claim 1, wherein the binder fiber comprises a low-melting-point polyethylene terephthalate fiber.

9. The undercover of claim 1, wherein the undercover has a structure in which two or more non-woven fabrics are layered.

10. The undercover of claim 1, wherein the undercover has a thickness of 3 mm or less.

11. The undercover of claim 1, wherein the undercover has a flexural strength of 15 MPa or more as measured according to ASTM C393.

12. The undercover of claim 1, wherein the undercover has a flexural load of 20 N or more as measured according to ASTM D790.

13. The undercover of claim 1, wherein the undercover has a flexural displacement of 20 mm or more as measured according to ASTM D790.

14. The undercover of claim 1, wherein the undercover has a flexural modulus of 1000 MPa or more as measured according to ASTM D790.

15. The undercover of claim 1, wherein the undercover has a moisture absorption rate of less than 1%.

16. A method for manufacturing an undercover, the method comprising:
preparing a regenerated fiber from a regenerated raw material comprising regenerated flakes and virgin chips;
preparing a non-woven fabric comprising the regenerated fiber and a binder fiber; and
integrating two or more non-woven fabrics by layering and needle-punching the two or more non-woven fabrics.

17. The method of claim 16, wherein the regenerated raw material has a moisture content of 100 ppm or less.

18. The method of claim 16, further comprising molding, with a mold, an integrated product formed in the integrating.

19. The method of claim 18, wherein the molding comprises:
introducing the integrated product without preheating into a preheated mold; and
pressing with the mold with steam being sprayed onto the integrated product.

20. The method of claim 19, wherein the pressing with the mold comprises pressing with a mold preheated to 150° C. to 200° C. with steam at 150° C. to 170° C. being sprayed onto the integrated product.
